(19) United States
(12) Patent Application Publication
(10) Pub. No.: US 2024/0263683 A1
(43) Pub. Date: Aug. 8, 2024

(54) ROUND CORNER EDGE LINK FOR FRICTION IMPROVEMENT

(71) Applicant: BorgWarner Inc., Auburn Hills, MI (US)

(72) Inventors: Shota TOMINAGA, Nabari, Mie (JP); Sho TANIMOTO, Nabari, Mie (JP)

(21) Appl. No.: 18/566,427

(22) PCT Filed: Jun. 7, 2021
(86) PCT No.: PCT/US2021/036176

§ 371 Date: Dec. 1, 2023

(51) Int. Cl. F16G 13/04; F16G 15/12

(52) U.S. Cl. CPC F16G 13/04; F16G 15/12

(57) ABSTRACT

A chain containing chain links with rounded chamfered edges to reduce friction loss between the link and a plastic face of the timing drive. The rounded chamfered edges preferably have a radius in a range of 0.14-0.33 mm.

### BACKGROUND

The present invention relates to chain links, and more specifically to a chain link with rounded corner edges that reduced friction between the chain link and plastic stationary guide members and tensioner faces.

### DESCRIPTION OF RELATED ART

Power transmission chains are useful in a variety of industries, including the automobile, bicycle and motorcycle industries. For purposes of positioning or tensioning a chain, stationary guide members and tensioners are placed in contact with the chain such that the chain is in sliding contact with these guide members and tensioner faces during chain operation. In the automobile industry, a timing drive typically includes a power transmission chain that transfers power from an engine crankshaft to one or more camshafts by means of toothed sprockets fixed to the crankshaft and the camshaft(s). In the interest of engine efficiency and noise reduction, a lubricating oil film is typically applied to reduce the friction that is generated when the chain slides past the guide member(s) during operation of the chain.

### SUMMARY

According to an embodiment of the present invention, a chain containing chain links with rounded chamfered edges are used to reduce friction loss between the chain link and a plastic face of the timing drive. The rounded chamfered edges preferably have a radius in a range of 0.14-0.33 mm.

### BRIEF DESCRIPTION OF THE DRAWINGS

FIG. 1 shows a front view of a link of an embodiment.

FIG. 2 shows a side view of the link of FIG. 1.

FIG. 3 shows a detailed view of FIG. 2.

FIG. 4 shows a graph of face loss torque versus speed with a tension load of 1000N for both a chain including links with chamfered edges and links without chamfered edges.

FIG. 5 shows a graph of face loss torque versus speed with a tension load of 500N for both a chain including links with chamfered edges and links without chamfered edges.

FIG. 6 shows a side view of link in contact with a plastic tensioner face.

FIG. 7 shows a chain including links of an embodiment of the present invention in contact with a plastic tensioner face.

### DETAILED DESCRIPTION

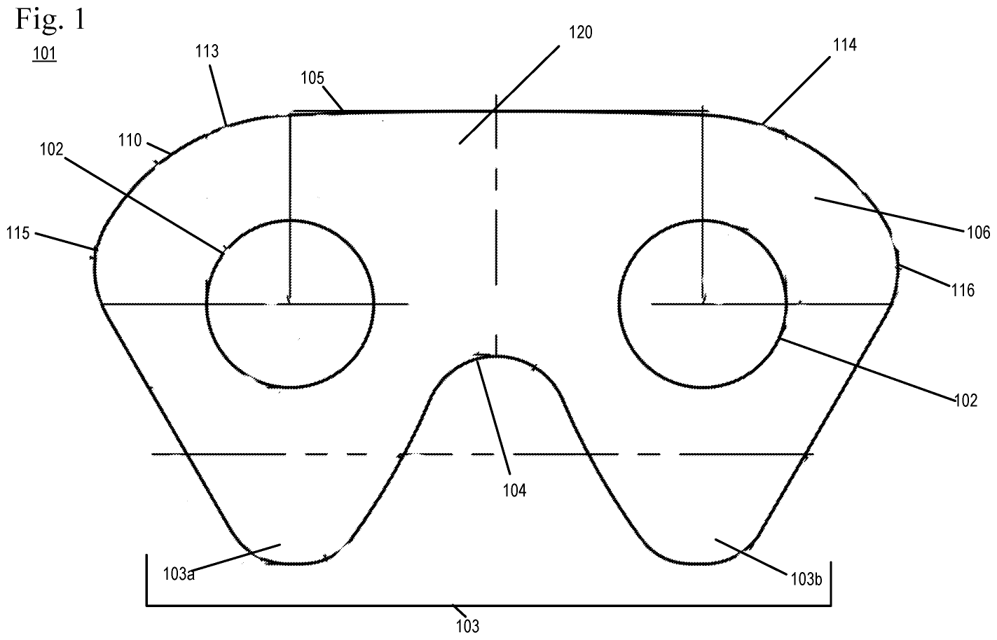

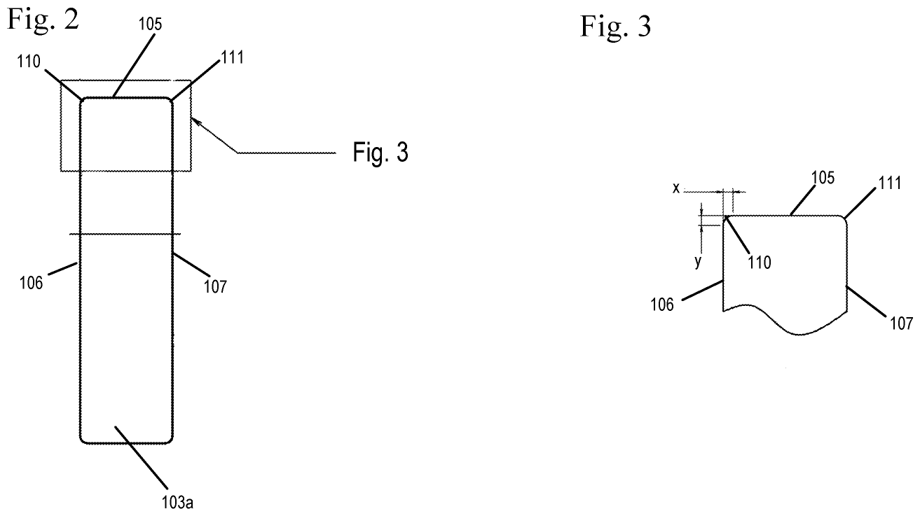

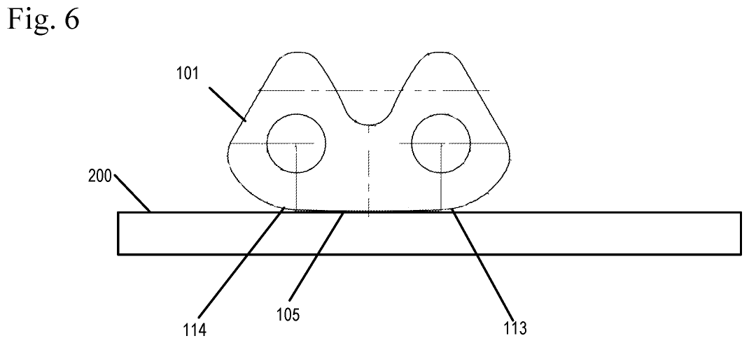

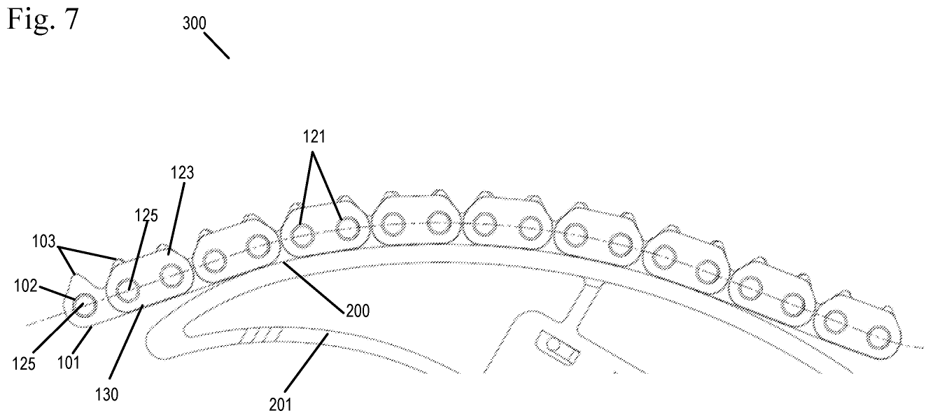

FIGS. 1-3 and 6 show a link of an embodiment of the present invention. FIG. 7 shows a chain including links of an embodiment of the present invention.

A chain 300 is formed of rows or sets of interleaved links 101 and guide links 130. Guide links 130 are present in a guide row and surround non guide rows of links 101.

Each of the links 101 have a body 120 defining a pair of pin holes or apertures 102 and a pair of teeth 103 consisting of a first tooth 103a and a second tooth 103b which mesh with sprockets (not depicted). The links 101 are arranged in the chain length direction and the chain width direction. The links 101 are linked so as to be able to pivot about one another by linking pins 125 which are inserted into the pin holes or apertures 102. The teeth 103a, 103b of the links 101 are linked by a crotch 104. The links 101 have a back surface part 105. The back surface part 105 can be radiused or flat. The back surface part 105 transitions through a back transition part 113, 114 to a shoulder 115, 116, which is connected to the teeth 103. The links 101 have a front face 106 and a back face 107 opposite the front face 106.

Each of the guide links 130 has a body 123 of a flat plate defining a pair of apertures 121. The guide links 130 are positioned on the lateral outside edges of the rows of interleaved links 101. The guide links 130 do not contain teeth, but extend adjacent to the region between the teeth 103 of the interleaved links 101. The guide links 130 are pivotably connected to the links 101 by the linking pins 125 inserted into apertures 121 of the guide links 130 and apertures 102 of link 101.

During use, the back surface part 105 of the links 101 comes into contact with a plastic guide or tensioner face 200. There may also be some contact of the back transition part 113, 114 with the plastic guide or tensioner face 200. In one embodiment, a radiused or chamfered edge 110 is present around the entire front face 106 between the transition between the front face 106 and the back face 107 on either side of the back surface part 105. A radiused or chamfered edge 111 can also present on the entire back face 107. Therefore, the radiused or chamfered edges 110, 111 can include the perimeter of the front face 106 and the perimeter of the back face 107, with the perimeter including the back surface part 105, the back transition part 113, shoulder 115, first tooth 103a, crotch 104, second tooth 103b, shoulder 116, and back transition part 114.

In another embodiment, the radiused or chamfered edge 110 is only required on the back surface part 105, the back transition part 113 and the back transition part 114 of the front face 106 and the back face 107 of the link which contact the plastic guide or tensioner face 200.

In one embodiment, the radiused or chamfered edges 110, 111 is created by tumbling processes which use an abrasive material to remove any sharp corners or surfaces created by the punching process to form the links. While the radiused or chamfered edges 110, 111 are present around the entire front and back faces 106, 107 of the link 101, it is preferable that the radius or chamfered edge 110, 111 is present on at least any surface that interfaces with the plastic face 200 of the tensioner arm or guide 201. The surfaces of the link 101 which interfaces with the plastic face 200 of the tensioner arm or guide 201 are the back surface part 105 and at least part of the shoulder surfaces 113, 114. By removing any sharp corners, there is no element or surface of the links 101 that can dig into or create excessive wear in the plastic face 200 of the tensioner arm or guide 201, reducing the edge load on the chamfered edges 110, 111 of the link 101 and the friction of the contact between the links 101 and the plastic face 200 of the tensioner or guide 201. The reduction of the friction between the links 101 and the plastic face 200 of the tensioner or guide 201 also reduces torque loss as a result of the friction.

The radius of the chamfered edges 110, 111 preferably have a radius of 0.14-0.33 mm. More specifically the x dimension is preferably 0.14-0.33 mm and the y dimension can vary. In another embodiment, the radius of the chamfered edges 110, 111 is 0.20 mm.

### Example

A single strand chain including links containing a chamfered edge in contact with a plastic face tensioner or guide was run on an engine for a break-in cycle. After the break-in cycle was completed, the chain was run at a variety of speeds and under two different tension loads, 500N and 1000N on a bench test stand.

A single strand chain including links not containing a chamfered edge in contact with a plastic face tensioner or guide was run under the same conditions as the chain containing links with the chamfered edge.

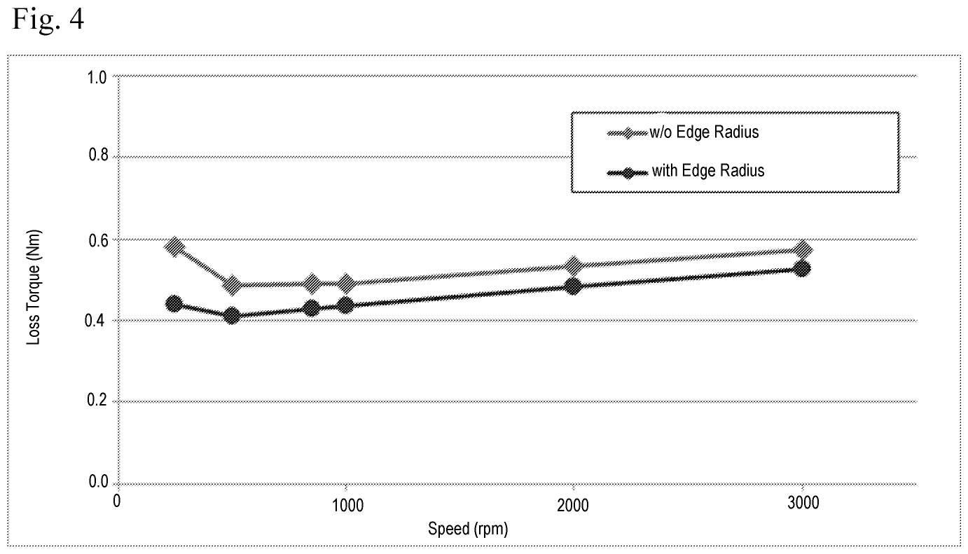

FIG. 4 shows the face loss torque in Nm versus speed when the chain was placed under a tension load of 1000N. The diamonds represent the chain containing links that do not contain a chamfered edge and the circles represent the chain containing links with chamfered edges as in the present invention. The face loss torque is the torque loss which results from the friction between the links, preferably the back surface part and the back transition part and the plastic face of the tensioner or guide.

As can be seen, a chain comprised of links that contain at least one chamfered edge suffered less of a loss of face torque between 0-3000 rpm than a chain comprised of links that contain no chamfered edges under a load of 1000N. The chain including the at least one chamfered edge had a 0.07 Nm improvement (e.g. less face loss torque) on average than the chain that did not have any chamfered edges. The chain including the at least one chamfered edge had a maximum improvement of 0.14 Nm at 250 rpm over the chain that did not include any chamfered edges.

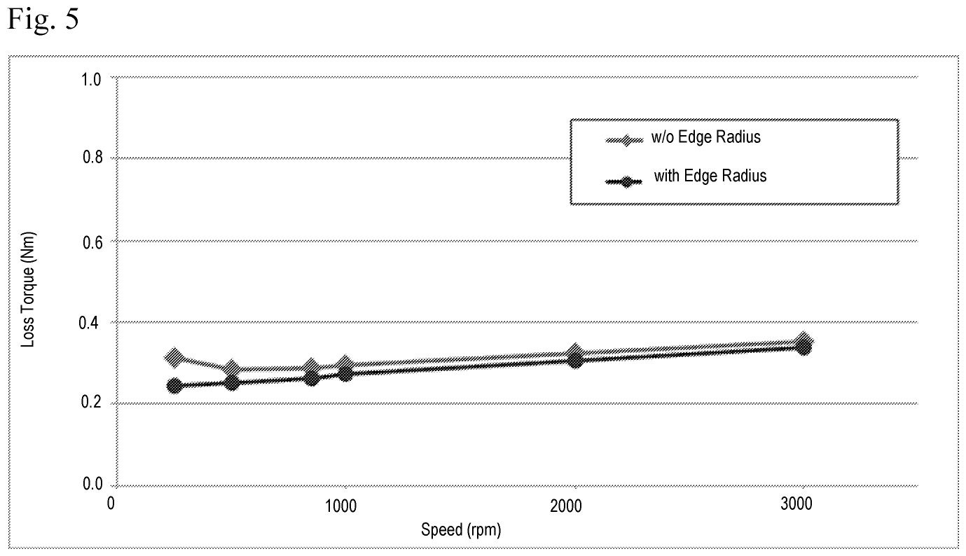

FIG. 5 shows the face loss torque in Nm versus speed when the chain was placed under a tension load of 500N. The diamonds represent the chain containing links that do not contain a chamfered edge and the circles represent the chain containing links with chamfered edges as in the present invention.

As can be seen, a chain comprised of links that contain at least one chamfered edge suffered less of a loss of face torque between 0-3000 rpm than a chain comprised of links that contain no chamfered edges under a load of 500N. The chain including the at least one chamfered edge had a 0.03 Nm improvement (e.g. less face loss torque) on average than the chain that did not have any chamfered edges. The chain including the at least one chamfered edge had a maximum improvement of 0.17 Nm at 250 rpm over the chain that did not include any chamfered edges. Therefore, the efficiency of the chain is increased as well as fuel economy.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A chain link having a link body comprising:
a front face having a front face chamfered edge of a radius of 0.14-0.33 mm;
a back face having a back face chamfered edge of a radius of 0.14-0.33 mm;
a back surface part connecting the front face to the back face;
a pair of teeth opposite the back surface part and connected to the back surface part through a shoulder and a back surface transition part;
a pair of pin holes defined by the link body between the back surface part and the pair of teeth extending from the front face to the back face; and
a crotch between the pair of teeth.

2. The chain link of claim 1, wherein the radius is 0.20 mm.

3. The chain link of claim 1, wherein the radius is formed through tumbling with an abrasive material.

4. A chain link having a link body comprising:
a front face having a front face chamfered edge;
a back face opposite the front face having a back face chamfered edge;
a back surface part connecting the front face to the back face;
a pair of teeth opposite the back surface part and connected to the back surface part through a shoulder and a back surface transition part;
a pair of pin holes defined by the link body between the back surface part and the pair of teeth extending from the front face to the back face; and
a crotch between the pair of teeth;
wherein the back surface part and the back surface transition parts of the front face have a front face chamfered edge and the back surface part and the back surface transition parts of the back face have a back face chamfered edge;
wherein the front face chamfered edge and the back surface chamfered edge each have a radius of 0.14-0.33 mm.

5. The chain link of claim 4, wherein the radius is 0.20 mm.

6. A silent chain comprising:
a plurality of link plates formed into rows, each of the link plates having a link body comprising:
a front face having a front face chamfered edge of a radius of 0.14-0.33 mm;
a back face having a back face chamfered edge of a radius of 0.14-0.33 mm;
a back surface part connecting the front face to the back face;
a pair of teeth opposite the back surface part and connected to the back surface part through a shoulder and a back surface transition part;
a pair of pin holes defined by the link body between the back surface part and the pair of teeth extending from the front face to the back face; and
a crotch between the pair of teeth;
the plurality of link plates arranged such that the pair of teeth and pin holes are stacked in the thickness direction and the lengthwise direction and are respectively coupled in a pivotable manner by connecting pins.

7. The silent chain of claim 6, wherein the radius is 0.20 mm.

8. The silent chain of claim 6, further comprising a plurality of guide links positioned on lateral outside edges of the rows of link plates.
